(19) United States
(12) Patent Application Publication
(10) Pub. No.: US 2013/0183504 A1
(43) Pub. Date: Jul. 18, 2013

(54) COMPOSITE BODIES

(71) Applicant: Senoplast Klepsch & Co. GmbH, Piesendorf (AT)

(72) Inventors: Gebhard Scheibner, Santa Rosa Jauregui (MX); Johann Kappacher, Piesendorf (AT); Alejandro Kukutschka Grajeda, Queretaro (MX)

(73) Assignee: Senoplast Klepsch & Co. GmbH, Piesendorf (AT)

(21) Appl. No.: 13/687,114

(22) Filed: Nov. 28, 2012

(30) Foreign Application Priority Data
Nov. 29, 2011 (EP) 11191130.1

(51) Int. Cl. B32B 27/08

(52) U.S. Cl. CPC B32B 27/08
USPC 428/213; 264/173.12

(57) ABSTRACT

A composite body including an optional transparent cover layer (1), comprising thermoplastic acrylic polymers and optionally UV additives, a coloured second layer (2) situated underneath, comprising thermoplastic acrylic polymers, colorants and optionally UV additives, an adhesion promoter layer (3) arranged underneath the coloured second layer (2), comprising a thermoplastic material, optionally comprising UV additives and/or colorants, a fourth layer (4) arranged underneath the adhesion promoter layer (3), comprising a thermoplastic material on the basis of polyolefin, additionally containing colorants, as well as optionally UV additives and additives, which improve the adhesion properties to the adhesion promoter layer (3) situated above; a substrate layer (5) arranged underneath the fourth layer (4), comprising accumulating waste and a thermoplastic material on the basis of polyolefin as well as colorants as well as a rear cover layer (6), comprising a thermoplastic material on the basis of polyolefin, in addition containing colorants.

### TECHNICAL FIELD

The invention relates to multi-layered composite bodies, comprising thermoplastic polyolefins and thermoplastic acrylic (co)polymers. The invention further relates to the production thereof, the processing thereof and the use of such multi-layered composite bodies as moulded bodies and to the use of these moulded bodies.

### BACKGROUND OF THE INVENTION

The use of flat composite bodies in an external surrounding is a great challenge for the materials used. The most important parameters are, for example, high UV and weathering stability, high scratch resistance, good resistance against chemical agents and good mechanical properties also under effect of heat and cold. Advantageous are, in this connection, materials, which—e.g., also having effect pigments—are coloured, as the colouring of components is rather effort- and cost-intensive.

Multi-layered thermoplastic components for external use are known from the literature. For example, H. Kappacher describes in Kunststoffe 86 (1996), p. 388 to 392 co-extruded, coloured PMMA/ABS composite plates.

DE 197 25 560 A1 describes multi-layered composite bodies, having a cover layer made of polymethyl methacrylate (PMMA) and a substrate layer situated underneath, optionally having an intermediate layer. The substrate layer is composed of a polymer alloy defined composition. The optional intermediate layer is composed of PMMA, polycarbonate (PC) or a moulded mass having an analogue composition as the polymer alloy defined in the substrate layer. In DE 197 25 560 A1 there is described that such composite bodies have improved dimensional stability in regard to heat in comparison with conventional ABS composite bodies.

EP 0 361 823 B1 describes foils on the basis of fluoro-containing polymers, which contain also acrylonitrile-butadiene-styrene-terpolymer (ABS).

The composite bodies mentioned in the three documents cited above are used in the automotive field and mainly consist of styrene copolymers (e.g., ABS), polycarbonate or blends thereof. These layered constructions are co-extruded or colaminated with polymethyl methacrylate or polyvinylidene fluoride as cover layer. Composite bodies of this type are characterized by good mechanical properties in the range of normal temperatures, they, however, also have deficits at temperatures below 20° Celsius.

Nevertheless, there are uses, for which the mechanical properties of the above mentioned composites are insufficient. For panelling parts in the field of utility vehicles, building devices or agricultural devices but also in the field of motor vehicles, e.g., for bumpers, increased properties in regard to the mechanical properties are specified, at normal temperatures as well as in the low temperature range of up to −40° C. For applications of this type, there are used other materials.

Polyolefins have proven to be useful in some fields. As materials for high-gloss surfaces for external use, however, these are not suitable. They have a very soft surface, which is rather prone to scratching, and the UV resistance is defective. Furthermore, their morphology is semi-crystalline, which leads to partially matt surfaces in the process of deep-drawing.

Hence, there has been searched for technical solutions in order to combine substrates on the basis of polyolefin with high-gloss, UV-resistant, scratching resistant and chemically resistant surfaces. As a material for the cover layer, also herein PMMA was taken into consideration. In the combination of PMMA with polyolefins, the problem of the incompatibility of both materials had to be solved in the first step. PMMA, as a polar material, does not adhere to non-polar polyolefins. Information in regard to the compatibility of various polymers may be found in “Einführung in die Kunststoffverarbeitung”; page 225; author: Walter Michaeli, Hanser Verlag, 5th edition, or also in “Kreislaufwirtschaftssystem Altauto”; page 249; 1st edition; author: Frank Wallau, Deutscher Universitätsverlag GmbH. Approaches to find a solution in order to establish the adhesion of PMMA on polyolefins in flat multi-layered composites are described in the following:

U.S. Pat. No. 6,420,050 B2 describes several different co-extrusion configurations having cover layers (A) made of blends, consisting of various percentages of polymethacrylate esters or polyacrylate esters, to which copolymers may be added: copolymers of vinyl-aromatic monomers and an aliphatically conjugated diene (these may also be chemically modified) or olefin-acrylate copolymers consisting of olefin and acrylate monomers. Situated underneath there is a substrate layer (B), consisting of polypropylene (PP) homopolymer (also filled), polypropylene or copolymers, polystyrene or maleic anhydride copolymers, block copolymers consisting of styrene and butadiene. The substances forming the substrate layer B may contain up to % fillers. The adhesion of the methacrylate cover layer to the polyolefin is achieved by admixing compatibility promoter agents.

U.S. Pat. No. 6,455,171B2 describes thermally deformable composite bodies, comprising a cover layer (A) made of 50-100% polymethacrylate esters or polyacrylate esters, an intermediate layer (C) consisting of (C1) olefin-acrylate polymers or (C2) block polymers of vinyl-aromatic dienes with aliphatically conjugated ones (also chemically modified) and a substrate (B). The intermediate layer C may also be a blend of C1 and C2. B consists of PP or copolymer of propylene and ethylene. Adhesion, in this case, is achieved by introducing an adhesion promoter layer. The production of composite bodies is realized by means of co-extrusion or lamination.

US 2008/0254308 A1 describes a substrate layer made of polyolefin and an adhesion promoter layer, onto which there is applied at least one further layer consisting of (impactmodified) polyalkyl(meth)acrylate. This cover layer may also contain UV stabilizers, additives and pigments. The thickness is defined from 0.1 to 38 mm. The layer configuration 10 is represented by co-extrusion or lamination. Also herein, there is introduced an adhesion promoter layer as an intermediate layer. The adhesion promoter layer is composed of a vinyl cyanide and a styrene block copolymer component.

In DE 195 47 720 A1 there is described a composite material, consisting of at least four layers, wherein there is assumed a polyolefin layer that is prepared from waste materials. Thereon there is applied a corona pre-treated polypropylene layer, onto which there is applied a primer on the basis of water. Onto this primer layer there is applied an adhesive layer, onto which there is subsequently laminated a decoration film consisting of PMMA or other polymers. There is also described the possibility to apply the adhesive layer onto the 20 decoration film. Also in this case, the assembling is realized by laminating or pressing. The described composite materials are also represented in several steps.

U.S. Pat. No. 6,652,985 B1 shows a lamination film on the basis of acrylic polymers, which film is provided at its rear side with a coloured adhesion promoter layer of various compositions and 25 which is laminated onto a substrate consisting of polyolefins. The multi-layered composite body is prepared by way of lamination.

US 2004/023037 A1 shows a multi-layered composite body, wherein an adhesion promoter layer consisting of a grafted polymer on the basis of polyolefin that is polymerized with methyl(meth)acrylate is applied onto a layer consisting of acrylic polymer, polyolefins or fluoropolymers. This second layer may also be arranged symmetrically so that there is formed the structure: acrylic polymer—grafted polymer (adhesion promoter)—polyolefin.

US 2008/0220274 A1 describes an acrylic film to be used on a thermoplastic olefin substrate, wherein polymers on the basis of functionalized acryl-olefin copolymers are being used as adhesion promoter layer. As basis for the functionalized acryl-olefin copolymers there is mentioned ethylene or propylene but also acrylacrylates. Functionalizing is performed by means of organic acid anhydride or unsaturated epoxides. The three layers may be coextruded, optionally also laminated.

The polymers in the three documents initially mentioned that are about layer configurations of styrene polymers (in particular ABS) and acrylates (in particular PMMA) are mutually compatible as alloys. This means that the mechanical properties will not be impaired, or only slightly, by using regenerates, regranulates, recyclates or ground material as an additive in the substrate layer depending on the quantity of the additive. All of the documents mentioned subsequently that are focused on polyolefinacrylate configurations describe composite bodies having layers made of incompatible polymers. In these documents, there is primarily described how polyacrylates are caused to adhere to polyolefins. Due to incompatibility of 10 polyolefins and polyacrylates, there cannot be used regenerates, regranulates, recyclates or ground material in the described layer configuration of prior art. In the preparation of such composite bodies there has to be rather frequently disposed of regenerates, regranulates, recyclates or ground material consisting of high-quality raw materials, or these are used for low-quality products. In total, this makes the preparation of multi-layered composite bodies on the basis of a co-extrudate of polyolefins and polyacrylates more expensive.

### SUMMARY OF THE INVENTION

For this reason, it was the task of the present invention to develop a flat, coloured and multilayered composite body on the basis of a co-extrudate of polyolefins and polyacrylates, which achieves approximately constantly good mechanical properties if accumulating regenerates, regranulates, recyclates and/or ground material are added and which thus meets the demanded technical as well as commercial requirements.

The task is solved by a multi-layered co-extruded composite body, which has the following layered configuration in the mentioned order:

(i) optionally a preferably transparent cover layer (1), comprising thermoplastic acrylic polymers,

(ii) a second layer (2), comprising thermoplastic acrylic polymers and preferably colorants,

(iii) an adhesion promoter layer (3), comprising a thermoplastic material, which adhesively connects the second layer (2) with the fourth layer (4) situated underneath,

(iv) a fourth layer (4) having a layer thickness of 1-50%, preferably 1 30% based on the thickness (d) of the composite body, comprising a thermoplastic material on the basis of polyolefin,

(v) a substrate layer (5), comprising 1-100% by weight, preferably 10-100% by weight, of accumulating waste as well as (vi) a sixth layer (6), comprising a thermoplastic material on the basis of polyolefin having a layer thickness (s6) of 1-50%, preferably 1-30%, based on the thickness (d) of the composite body.

The invention is based on the surprising finding that composite bodies having this layer configuration nevertheless show nearly the same mechanical properties—although they have mixtures of plastics in the substrate layer, which are incompatible per se—as if the layers each were composed of compatible plastics. The layers mentioned before immediately adjoin each other in the order mentioned, this is, there are not existent any further intermediate layers.

### BRIEF DESCRIPTION OF THE DRAWING

For a more complete understanding of this invention reference should now be made to the drawing wherein:

FIG. 1 is a composite body according to the disclosed invention.

### DETAILED DESCRIPTION OF THE PREFERRED EMBODIMENT

The present invention is disclosed in detail as follows.

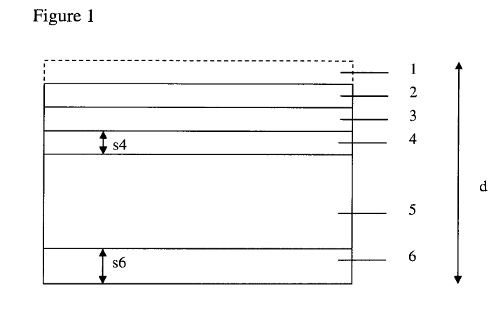

A composite body according to the invention is illustrated in FIG. 1.

The layer configuration is as follows: The optional cover layer 1 (thus depicted in dotted lines) essentially is composed of a thermoplastic acrylic polymer like PMMA, HI-PMMA or a mixture thereof. Situated underneath is the second layer 2, which is also essentially composed of PMMA, HI-PMMA or a mixture of these two. In addition, there is provided in the second layer 2 colorants, for example effect pigments, and optionally UV additives. Situated underneath the second layer 2, there is arranged the adhesion promoter layer 3, which—as known per se—represents adhesion between PMMA and polyolefin. Situated underneath the adhesion promoter layer 3, there is existent the fourth layer 4, which is composed of thermoplastic polyolefin (e.g., PP) and colorants (for example dyes). The layer thickness s4 of the fourth layer 4 is preferably between 1 and 30% based on the total thickness d of the 20 composite body. Situated underneath the fourth layer 4, there is the substrate layer 5, which contains between 1 and 100% by weight, preferably between 10 and 100% by weight of accumulating waste of the method of preparation. The accumulating waste may be composed of a mixture of all components of the individual layers. The remaining amount up to 100% by weight is composed of thermoplastic materials on the basis of polyolefin as well as optionally additives and colorants. Situated underneath the substrate layer 5, there is present the sixth layer 6, comprising a thermoplastic material on the basis of polyolefin, which may optionally also contain colorants and various additives and modifiers. The layer thickness s6 of the sixth 30 layer 6 is preferably about 1 to 30% based on the total thickness d of the composite body.

### Recycling of Plastic Material

The most important definitions of terminology in the recycling of plastics are cited. The following definitions have been found in the book “Werkstoff-Führer Kunststoffe: Eigenschaften, Prüfungen, Kennwerte”—HANSER Verlag, 10th 35 edition, page 51 (translation):

1. Recyclate is a general term; this is a moulded mass or a processed plastic having defined properties. In many cases, the recyclate is mixed with new materials. A recyclate has already gone through a processing step. A master batch or a blend, which have been prepared from several plastics by way of recycling, this is by way of a processing step, are not considered as recyclates.
2. Ground material is prepared by grinding plastic. Ground material has different and irregular particle sizes from 2 mm to 5 mm, and it may contain dust portions.
3. Regranulate is prepared from ground material via a melting process as granulate. Regranulate has a regular corn size and no dust portion, thus being processable without any further problems.
4. Regenerate is prepared by way of a melting process (compounding), wherein additives are added in order to improve the properties thereof. A regenerate has a regular corn size and no dust portion and optionally defined characteristic values.

Further important terms in the connex of recycling are purity and compatibility of the starting materials:

Of a singular type means that only one plastic of a raw material producer is processed having the same type designation.
Of a singular type means that plastics having the same designation according to DIN EN ISO 11469 or VDA 260, respectively, or optionally of various raw material producers are processed.
Of a similar sort means that the plastics to be processed coincide in their basic polymers, but differ from each other in particular properties such as, e.g., flame-retardant additives.
Mixed means that different plastics being chemically compatible are processed (ABS and PC). Plastics are compatible if they can be mixed with each other in the molten mass and can then be processed into a moulded material having satisfying mechanical properties and an acceptable surface.
Contaminated means that the plastics to be processed still contain substances of the preceding use, which impede the properties of the moulded part to be prepared therefrom.
Accumulating waste: This term has not been defined in the literature so far; in order to simplify matters, in the sense of the invention, accumulating waste is a general term combining the terms mentioned above, this is recyclate, ground material, regranulate and regenerate, and the sub-ordinate terms of purity and compatibility.

Whether the recycling of plastic material makes sense, will be explained in the case according to the invention as follows: When the co-extrusion plant is implemented and adjusted, various parameters such as, e.g., the total thickness, the predefined thicknesses of the individual layers, the width, the homogenous thickness of the individual layers across the width and the colour predetermined by the customer, have to be adapted and adjusted so that these meet the configuration or the requirements, respectively, predefined. The same process has to be selected, if, according to the customer's wish, the total thickness, the width or the colours are changed. Also cutting into the predefined dimensions (length and width) is realized in-line which means that the surplus is cut off and accumulates as waste (“accumulating waste”). During this processes of adjustment and re-arrangement there is produced 5 material, which, however, does not have the composition of the final product but which will not anymore be supplied to the process according to the state of the art. If the accumulating waste is not added to the process, this will have a negative impact on the commercial success of the product: The accumulating waste has to be included in the calculations, as the raw material is de facto consumed, thus the customer has to pay for the entire material used but will receive only a part of the material (the part, which has been processed into the semi-finished goods according to contract). The residue, this is the accumulating waste, is of no use for the client. In addition, there is given an ecological aspect, as this accumulating waste has to be disposed of, as this material in general cannot be sold.

The rather obvious solution would be to shredder the accumulating waste in order to produce ground material, which is then re-added to the multi-layered composite, such as, e.g., in the substrate layer. Due to the material incompatibility of polyolefin and TPO with PMMA, this, however, results in the decrease of the mechanical properties as shown in table, which is why the advantages and benefits of the material combination and the original intention in the use of TPO will be lost.

Mixed ground materials (e.g., of the co-extrusion of acrylonitrile-butadienestyrene terpolymer (ABS) with acrylonitrile-styrene-acrylic ester terpolymers (ASA)), which develop due to the implementation of the extrusion plant, due to change of dimension or colour or due to the rinsing of the plant, may be re-fed into the substrate layer in co-extrudates, in which thermoplastics of a similar sort or compatible with each other are combined. Depending on the quantity of the regenerate used, in this case the mechanical properties of the semi-finished goods will not be reduced at all or only slightly.

In the present case of the co-extrusion of polyolefin with polymethyl methacrylate, there is obtained ground material that is contaminated according to the above definition by shreddering the co-extrusion wastes formed in the implementation the plant, due to changes in dimension or colour or due to the rinsing the plant. The material is contaminated, as PMMA 35 negatively affects the properties of polyolefin due to the mutual incompatibility thereof. This is illustrated by way of table 1, which shows to which extent the mechanical properties of polyolefin are decreasing in mixtures with PMMA:

TABLE 1
Mechanical behaviour of PP in mixtures with polymethyl methacrylate
(decrease in percentage in regard to starting value)

| Composition in | | 90% PP + | 80% PP + |
|---|---|---|---|
| % by weight | 100% PP | 10% PMMA | 20% PMMA |
| Total energy | 38.9 | 2.5 (−93.6%) | 1.5 (−96.1%) |
| Impact strength | 11.5 | 6.0 (−47.8%) | 3.9 (−66.1%) |
| Elongation at break | 248 | 24 (−90.3%) | 4.4 (−98.2%) |

“Total energy” is measured according to ÖNORM EN ISO 6603-2, edition 2002-04-01: “Plastics Determination of puncture impact behaviour of rigid plastics”, part 2: instrumented impact testing (ISO 6603-2:2000), [ ]=joule, measured at room temperature, injection-moulded test bodies having a thickness of 2.2 mm. “Impact strength” is measured according to ISO DIN EN 179-1eA “Plastics—Determination of Charpy impact properties”, part 1: non-instrumented impact properties, edition November 2010, [ ]=kJ/m², measured at room temperature “Elongation at break” according to ISO DIN EN 527-2 “Determination of tensile properties”, edition July 1996, [ ]32%, measured at room temperature “PP” (polypropylene) BC240TF by the company BOREALIS “PMMA” (polymethyl methacrylate) Plex 7M by the company ROHM

In the following table 2, there are indicated test results for comparative purposes, which show the correlation in the mechanical behaviour of ABS in mixtures with PMMA. Accordingly, in the production of blends from materials having good compatibility there are produced materials having good mechanical properties, so that there have to be expected only small decreases of the mechanical properties if regenerates, regranulates, recyclates or ground material are used.

TABLE 2
Mechanical behaviour of acrylonitrile-butadiene-styrene terpolymer
in mixtures with polymethyl methacrylate (decrease in percentage
in regard to starting material; composition in % by weight)

| | | 90% ABS + | 80% ABS + |
|---|---|---|---|
| Composition | 100% ABS⁴⁾ | 10% HI-PMMA | 20% HI-PMMA |
| Total energy | 42.8 | 44.6 (+4.2%) | 34.2 (−25.1%) |
| Impact strength | 32.7 | 21.4 (−34.5%) | 15.9 (−51.4%) |
| Elongation at break | 113 | 89 (−21.1%) | 82 (−27.4%) |

“Total energy” is measured according to ÖNORM EN ISO 6603-2, edition 2002-04-01: “Plastics Determination of puncture impact behaviour of rigid plastics”, part 2: instrumented impact testing (ISO 6603-2:2000), [ ]=joule, measured at room temperature, injection-moulded test bodies having a thickness of 2.2 mm. “Impact strength” is measured according to ISO DIN EN 179-1eA “Plastics—“Determination of Charpy impact properties”, part 1: non-instrumented impact properties, edition November 2010, [ ]=kJ/m², measured at room temperature “Elongation at break” according to ISO DIN EN 527-2 “Determination of tensile properties”, edition July 1996, [ ]32%, measured at room temperature
“ABS” (acrylonitrile-butadiene-styrene terpolymer) Magnum 3904 by the company STYRON
“HI-PMMA” (impact modified polymethyl methacrylate) Altuglas MI7T by the company ARKEMA

Comparison of the two tables clearly shows that using accumulating waste does not present any problem in compatible plastics, as it will inevitably lead to uselessness of the product in the case of incompatible plastics.

Another source of accumulating waste is the result of the consequent processes of deep drawing and trimming: deep-drawn components made of multi-layered semi-finished goods are trimmed following deep drawing: the three-dimensional parts are cut according to their predetermined geometry. These sections are ground by means of shredders and in turn give way to contaminated ground material in the multi-layered composites according to the invention, which is then added, at the request of the customer, to the inventive multi-layered, co-extruded composite bodies.

It is further possible to feed this contaminated ground material to a processing step and, hence, to produce contaminated regranulate, which may then be as such used in the substrate layer (5) of the configuration according to the invention.

It is also possible to provide the contaminated ground material with compatibility promoters in order to improve the compatibility of the materials of the cover layer (1) and of the coloured second layer (2) with the materials of the layers (3), (4), (5) and (6). As examples of compatibility promoters, there may be used alkenealkylacrylate copolymers (such as, e.g., ethylene-ethylacrylate copolymer EEA) as well as modifications (e.g., maleic anhydride, grafted ethylene-ethylacrylate copolymer), grafted polymers and copolymers (such as, e.g., maleic acid grafted polyethylene) or copolymers on the basis of ethylene-vinyl acetate (EVA).

According to the invention, there is also provided the use of impact resistant modified additives in accumulating waste, by means of which the mechanical properties may be improved. Mixtures of this type may also be used in the substrate layer (5).

### Method of Production

Composite bodies according to the invention are preferably produced in the co-extrusion method. This is characterized in that this method combines plastic molten materials of the same type or a different type before the exit through an exit nozzle. For the configuration according to the invention, the molten materials of the layers (1), (2), (3), (4), (5) and (6) are combined by an adapter or in a multi-channel nozzle or a combination thereof and then expelled through the nozzle, moved across a smoothing calendar and cooled. Cooling is realized in general by the semi-finished products being moved across a cooling leer and subsequently being cut in the width. Cutting in the longitudinal direction is performed before the de-stacking process.

### Processing of the Semi-Finished Goods

Components made of composite bodies, as defined above and in the attached claims, may be produced from flat composite bodies (semi-finished products) by means of thermal deformation (thermoforming). Thereby, the composite bodies are heated in a deep drawing machine beyond the softening point and immediately afterwards drawn across a tempered mould. By applying vacuum in the air space between the thermoplastic semi-finished product and the tempered mould, the semi-finished product will then be pressed towards the mould, it will be cooled and then deformed. Subsequently, the mould blank is trimmed to the correct dimensions, by means of which a three-dimensional component having a defined and very well reproducible geometry is being obtained.

### Optional Cover Layer (1)

The optional cover layer (1) comprises an acrylic polymer or copolymer, in the preferred case polymethyl methacrylate (PMMA), impact modified PMMA (HI-PMMA) or a blend thereof. Optionally, the cover layer (1) may have UV additives to the extent of respectively 0.01 to 8% by weight. Thus the materials and colorants used in the coloured layer (2) are in addition protected against UV radiation, which is why the colour stability is significantly improved beyond the duration of use in the case of irradiation with UV light. The most important properties of PMMA are summarized in Hans Domininghaus, “Die Kunststoffe und ihre Eigenschaften”, edition 1998, page 455-481. PMMA as a material for the cover layer guarantees, apart from very high UV resistance, also very good resistance against scratching and chemical substances as well as high surface gloss. The cover layer 1 preferably, apart from acrylic (co)polymers (including any impact resistance modifiers) and UV additives, does not have any further ingredients.

The cover layer may be provided with a protective film for transport, storage and thedeformation process. It protects the acrylic polymer surface during handling againstmechanical damage. In general, this is removed only after final mounting of the component.

### Coloured Second Layer (2)

The coloured second layer (2) comprises an acrylic polymer or copolymer, in the preferred case polymethyl methacrylate (PMMA), impact modified PMMA (HIPMMA) or a blend thereof. The layer is coloured especially preferably with colorants. Optionally, the coloured second layer (2) may also have UV additives in order to achieve a higher UV resistance of the used colorants and of the composite. PMMA is especially suitable as a material for this layer, as it shows high rigidness and resistance against scratching and is transparent. By using HIPMMA, optionally also in mixture with PMMA; the multi-layered co-extruded composite may be improved in regard to its mechanical properties. To the acrylic polymers or copolymers that are contained in the coloured second layer (2) may further also be added additives, which improve the adhesive strength to the adhesion promoter layer (3) situated underneath. As an example, there are to be mentioned ethylene, alkylacrylate copolymers or copolymers of ethylene-alkylacrylate-maleic anhydride.

### Adhesion Promoter Layer (3)

Adhesion promoter layers are frequently used for the anchoring of different layers, in particular if the materials of the layers, which are to be anchored with each other, are not compatible with each other. In the inventive case, polyolefins (also very apolar materials) are to be joined face-to-face with polyacrylates (also very apolar materials). Due to their chemical structure and their physic-chemical properties, these materials cannot be co-extruded together achieving good adhesion. For this reason, here is inserted an adhesion promoter layer (3). Adhesion promoters, which combine polyolefins with polyacrylates, are offered in various chemical structures. The multi-layered configuration according to the invention includes, as an adhesion promoter, any thermoplasts or thermoplastic elastomers, which may be processed by means of coextrusion and which result in improved adhesion between the coloured second layer (2) and the fourth layer (4) situated underneath. Sufficient adhesion, however, is meant not only as adhesion at the point of time immediately following the preparation of the semi-finished products but rather also adhesion following further processing steps and also in the application under the requirements necessary.

As examples of materials, which may be processed into adhesion promoter layers, are to be mentioned, for example: copolymers on the basis of alkylenealkylacrylates and the chemical modifications thereof or styrene copolymers, the derivatives and modifications thereof. The adhesion promoter layer (3) may optionally be coloured with a colorant, further also with effect pigments. In order to improve UV stability, the layer may also be provided with UV additives, which, firstly, improve the behaviour of the layer per se in regard to UV radiation and, secondly, also the UV stability of the fourth layer (4) situated underneath.

### Fourth Layer (4)

The fourth layer (4) that is situated underneath the adhesion promoter layer (3) is composed of thermoplastic materials on the basis of polyolefins, optionally colorants, UV additives and additives for the promotion of adhesion.

By thermoplastic materials on the basis of polyolefin in the sense of the invention, there is understood polyolefin, which is distinguished into homo-polymers, copolymers, terpolymers or blends thereof. Polymers of the preferred structure may be composed of one or several monomers on the basis of polyolefin, such as, e.g., ethylene, propylene or copolymers, and they may have a linear and/or branched molecular geometry. Polyolefins, in particular polypropylenes, may be modified with elastomers; also fillers may be added. The elastomeric phase (or also disperse phase) may in general be composed of a rubber (e.g., EPDM=ethylene-propylene-diene rubber) or of a styrene block copolymer or a mixture thereof. The continuous phase is composed of at least one polyolefin component. Polymer blends of this type are commonly designated as polyolefin elastomers (TPO or TPE-O) and, in the sense of the invention, are considered thermoplastic materials on the basis of polyolefin. Elastomeric thermoplasts on the basis of PP (TPO) represent blends having improved mechanical properties. Thermoplastic elastomers are plastics, which behave similarly to the traditional elastomers at room temperature, but may be plastically deformed when heat is supplied and thus show a thermoplastic behaviour.

There is not added any accumulating waste in the layer to the fourth layer 4. Depending on the quality of the mechanical properties of the accumulating waste, which is added in the substrate layer (5), and on the requirements stipulated by the customers in regard to the mechanical properties for the multi-layered, co-extruded composite body, it is possible to vary the layer thickness and/or the chemical composition of the fourth layer (4). Using accumulating waste having low mechanical properties in the substrate layer 5 may either result in increasing the layer thickness, or impact modifiers (e.g., rubber) may be added. The layer thickness (s4) of the fourth layer (4) is 1-50%, preferably 1-30% based on the total thickness (d) of the composite body. Colorants may be added to this fourth layer 4; it is also possible to add UV additives. There may be further added additives, which improve the adhesive characteristics towards the adhesion promoter layer (3) situated above. In this way, there may be added, for example, ethylene-vinyl acetate copolymers to the layer.

### Substrate Layer (5)

According to the invention, there are added to the substrate layer (5), in the sense of the recycling of plastic material, accumulating waste of the co-extrusion process or the consequent processes to an extent of 1-100% by weight, preferably 10100% by weight. If the content of acrylic polymer or copolymer is too high, and, hence, the mechanical properties of the added accumulated waste are too low, there is given, according to the invention, also the option of adding to the added accumulated waste also compatibilizers or impact modifiers in order to improve the mechanical properties. The added quantity of additives of this type is based in this case on the dimension of the mechanical properties: The lower the mechanical properties are, the bigger the added quantity of additives of this type is. As an example there are to be mentioned alkylacrylate copolymers, styrene-ethylene-butadiene-styrene copolymers as well as the chemical modifications thereof. Also reactive compatibilizers are conceivable, by means of which the incompatible phases of the acrylic polymers or copolymers and of the thermoplastic materials on the basis of polyolefin may be chemically bound. As examples thereof, there may be mentioned alkyl-acrylic ester-maleic anhydride terpolymers.

The substrate layer 5 may further have thermoplastic materials on the basis of polyolefin (see definition of the fourth layer 4 above). In addition, there may be added fillers or additives such as, e.g., UV absorbers and UV stabilizers, lubricants, oxidation stabilizers, flame retardants, synergists, colorants and/or fillers. As fillers there may, for example, be mentioned: mica, talcum, calcium carbonate, wollastonite, dolomite, glass fibres, and boron fibres, optionally other fibres of inorganic origin, carbon fibres and fibres of organic origin (e.g., flax fibres or cellulose fibres). In this way, the spectrum of the mechanical properties (rigidness, service temperature range, etc.) is significantly increased. The fillers may be pretreated in order to improve the adhesive behaviour between the filler and the polymeric matrix. There may be used, for example, fatty acids such as stearic acid, silanes, palmitic acids, modified polypropylenes and the like.

### Sixth Layer (6)

The sixth layer (6) is composed of thermoplastic materials on the basis of polyolefin (see above definition of fourth layer 4). No accumulating waste is added in the layer. Depending on the quality of the mechanical properties of the accumulating waste, which is added in the substrate layer (5), and on the requirements stipulated by the customers in regard to the mechanical properties for the multi-layered, co-extruded composite body, it is possible to vary the layer thickness and/or the chemical composition of the sixth layer (6). Using accumulating waste with low mechanical properties, it is possible to either increase the layer thickness or to add impact modifiers (e.g., rubber). It is also possible to combine the increase of the layer thickness and the addition of an impact modifier (e.g., rubber). The layer thickness (s6) of the sixth layer (6) is 1-50%, preferably 1-30% based on the total thickness (d) of the composite body, and it is optionally provided with colorants. Unless the addition of additives does not lead to a matt rear side in the thermoplastic material on the basis of polyolefin, it is possible to optionally matt these by way of suitable additives, either chemically or mechanically.

As thermoplastic materials on the basis of polyolefin have deficient adhesive characteristics in the case of adhesion or enhancement (e.g., glass fibre enhanced polyurethanes or polyesters), chemical adhesion promoters may be added to the rear-side cover layer (6): examples hereof are ethylene-vinyl acetate copolymers with polyethylene or maleic anhydride grafted polypropylenes with polypropylene. In both cases, the polarity of the surface is increased by the added comonomers, resulting in improved adhesive behaviour. Pre-treatment of the surface by way of activation is expedient. This is realized by way of corona treatment, flame treatment, plasma treatment or fluorination.

### UV Additives

The ultraviolet portion of the sun light destroys the chemical bonds in polymers in the course of a process that is called photodegradation. This causes, by chemical changes in the polymer, also changes in the chemical or physical behaviour. The results of these reactions are, for example, fracture, discolouration and colour changes. In order to prevent or retard such effects UV additives may be added. Depending on the mode of action of these UV additives, there is distinguished between UV absorber and UV stabilizer. UV absorbers cause the absorption of the UV portion of the light, which passes through the polymer, and convert this into thermal energy. As an example of very efficient UV absorbers there are to be mentioned benzophenons. UV stabilizers inhibit free radicals, which are formed by the irradiation with UV radiation, and stop further disintegration. As an example of very efficient stabilizers there are to be mentioned HALS (hindered amine light stabilizers).

### Colorants

In accordance with DIN 55943, a colorant is the general designation of all colouring substances. Colorants are distinguished by their chemical structure into inorganic colorants, on the one side, and into organic colorants, on the other one. In both groups there may be differed between natural and synthetic colorants, or between white, coloured or black colorants, according to the colour quality, or between effect and fluorescent colorants.

Inorganic colorants are usually pigments. The organic colorants are divided into insoluble pigments or soluble colorants, depending on their solubility in the respective medium of application. Pigments in the application medium are insoluble colorants, whereas colorants are soluble in the application medium.

Effect pigments, as used in the second layer (2), may be divided into two big glasses in pursuance with literature, Gunter Buxbaum, “Industrial Inorganic Pigments”, edition 1993, page 207-224: the pearlescent pigments and the metal effect pigments. Pigments of this type may also be used in order to achieve special visual effects; they may also be used in combination with normal pigments and/or colorants.

### EXAMPLES

In the following the invention is illustrated by way of examples. Therefore, there have been produced different composite bodies using the co-extrusion method. There was used a plant consisting of 6 extruders for the production of the composite bodies. The molten material of the individual extruders was then combined in an adapter system, discharged via a nozzle having an exit width of 1800 mm and smoothed in the up stack calandering method, moved across a cooling leer having a length of 15 metres and consequently trimmed in the transversal and the longitudinal direction.

### Example 1

### Composite Body without Addition of Accumulating Waste

Total thickness: 3.54 mm
Cover layer (1): Thickness 0.14 mm: 100% HI-PMMA
Second layer (2): Thickness 0.105 mm 100% HI-PMMA+colouration
Adhesion promoter layer (3): Thickness 0.071 mm 100% adhesion promoter+Colouration
Fourth layer (4): Thickness 0.35 mm 100% TPO+colouration
Substrate layer (5): Thickness 2.826 mm 100% TPO

### Example 2

### Configuration with 100% Accumulating Waste in the Substrate Layer, No Fourth Layer (4), No Sixth Layer (6)

Total thickness: 3.52 mm
Cover layer (1): Thickness 0.14 mm 100% HI-PMMA
Second layer (2): Thickness 0.109 mm 100% HI-PMMA+colouration 35
Adhesion promoter layer (3): Thickness 0.074 mm 100% adhesion promoter+Colouration
Substrate layer (5): Thickness 3.182 mm 100% accumulating waste

### Example 3

### Configuration with 100% Accumulating Waste in the Substrate Layer, No Sixth Layer (6)

Total thickness: 3.50 mm
Cover layer (1): Thickness 0.14 mm 100% HI-PMMA
Second layer (2): Thickness 0.107 mm 100% HI-PMMA+colouration
Adhesion promoter layer (3): Thickness 0.071 mm 100% adhesion promoter+colouration
Fourth layer (4): Thickness 0.35 mm 100% TPO+colouration
Substrate layer (5): Thickness 2.832 mm 100% accumulating waste

### Example 4

### Configuration with 100% Accumulating Waste in the Substrate Layer (5), with Fourth Layer (4) and Sixth Layer (6) [Configuration According to the Invention]

Total thickness: 3.50 mm
Cover layer (1): Thickness 0.14 mm 100% HI-PMMA
Second layer (2): Thickness 0.105 mm 100% HI-PMMA+colouration
Adhesion promoter layer (3): Thickness 0.070 mm 100% adhesion promoter+Colouration
Fourth layer (4): Thickness 0.36 mm 100% TPO+colouration
Substrate layer (5): Thickness 2.465 mm 100% accumulating waste
Sixth layer (6): Thickness 0.36 mm 100% TPO+colouration

The mechanical values of the composites described are listed in the following table 3.

TABLE 3
Mechanical behaviour of multi-layered, co-extruded
composite bodies on the basis of 25 PMMA-TPO

| | Example 1 | Example 2 | Example 3 | Example 4 |
|---|---|---|---|---|
| Total energy | 40.15 | 18.81 | 22.32 | 37.86 |
| Charpy | 57.95 | 15.33 | 17.26 | 36.52 |
| impact | | | | |
| resistance | | | | |
| Elongation at | 28.43 | 21.17 | 28.43 | 29.08 |
| break | | | | |

“Total energy” is measured according to ONORM EN ISO 6603-2, edition 2002-04-01: “Plastics Determination of puncture impact behaviour of rigid plastics”, part 2: instrumented impact testing (ISO 6603-2:2000), [ ]=joule, measured at room temperature,
“Charpy impact resistance” is 30 measured according to ISO DIN EN 179-1eA “Plastics—Determination of Charpy impact properties”, part 1: non-instrumented impact properties, edition November 2010, [ ]=kJ/m², measured at room temperature
“Elongation at break” according to ISO DIN EN 527-2 “Determination of tensile properties”, edition July 1996, [ ]32%, measured at room temperature

As the examples show, in comparison with the idealized example 1, which has been produced without any accumulating waste, there was observed in the examples 2 and 3 a significant mechanical decrease if the layer configuration according to the invention had not been selected. In the example 4 according to the invention the representation of waste is rather low in the total energy, and it is proportionally low in the Charpy impact resistance, even though the substrate layer consists of accumulating waste to 100%, this is the worst configuration possible according to the invention. This improvement in the mechanical properties thus is a result of the layer configuration.

1. A composite body, comprising in the mentioned order:
(i) optionally a cover layer, comprising thermoplastic acrylic polymers,
(ii) a second layer, comprising thermoplastic acrylic polymers 5 and colorants,
(iii) an adhesion promoter layer, comprising a thermoplastic material, which adhesively connects the second layer with the fourth layer situated underneath,
(iv) a fourth layer having a layer thickness of 1-50% based on the thickness of the composite body, comprising a thermoplastic material on the basis of polyolefin,
(v) a substrate layer, comprising 1-100% by weight of accumulating waste as well as
(vi) a sixth layer, comprising a thermoplastic material on the basis of polyolefin, having a layer thickness of 1-50% based on the thickness of the composite body.

2. A composite body according to claim 1, wherein the acrylic polymer of the cover layer is PMMA, HI-PMMA or a blend thereof.

3. A composite body according to claim 1, wherein the acrylic polymer of the second layer is PMMA, HI-PMMA or a blend thereof.

4. A composite body according to claim 1, wherein at least one of the layers selected from the adhesion promoter layer, the fourth layer, the substrate layer or the sixth layer in addition contains colorants.

5. A composite body according to claim 1, wherein the substrate layer additionally has a thermoplastic polyolefin material.

6. A composite body according to claim 1, wherein the substrate layer contains compatibilizers, impact modifiers or a combination thereof.

7. A composite body according to claim 1, wherein the substrate layer additionally has at least one filler.

8. A composite body according to claim 1, wherein the second layer or the fourth layer or second layer and fourth layer have additives for improving the adhesion to the adhesion promoter layer.

9. A composite body according to claim 1, wherein the fourth layer or the sixth layer or fourth layer and sixth layer have additives for improving the mechanical properties.

10. A composite body according to claim 1, wherein the sixth layer 5 is chemically, physically or chemically and physically matted.

11. A composite body according to claim 1, wherein the sixth layer has adhesion promoters.

12. A composite body according to claim 1, wherein there is applied to the second layer or, if there is existent a cover layer, to the cover layer a removable protective film.

13. A composite body according to claim 1, wherein at least one of the layers contains UV 15 additives.

14. A composite body according to claim 1, wherein the fourth layer has a layer thickness of 1-30% based on the thickness of the composite body.

15. A composite body according to claim 1, wherein the substrate layer comprises 10-100% by weight of accumulating waste.

16. A composite body according to claim 1, wherein the sixth layer has a layer thickness of y 1-30% based on the thickness of the composite body.

17. A composite body according to claim 6, wherein the substrate layer contains alkylacrylate copolymers, styrene-ethylene-butadiene-styrene copolymers, alkyl-acrylic ester-maleic anhydride terpolymers as well as chemical modifications thereof.

18. A composite body according to claim 11, wherein the sixth layer has adhesion promoters selected from the group ethylene-vinyl acetate copolymers or polypropylenes grafted with maleic anhydride.

19. A method for the production of a composite body claim 1, wherein the materials for the individual layers are each fed to an extruder and subsequently co-extruded, wherein 1-100% by weight of accumulating waste are added to the materials for the substrate layer.

20. A moulded part containing a composite body according to claim 1.

21. A moulded part according to claim 20 that is selected from the group of car body parts, panelling parts and the like.
